(19) United States
(12) Patent Application Publication
(10) Pub. No.: US 2009/0248716 A1
(43) Pub. Date: Oct. 1, 2009

(54) Hierarchy creation and management tool

(75) Inventor: Kiran Mohare, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/078,424

(22) Filed: Mar. 31, 2008

(51) Int. Cl. G06F 17/30

(52) U.S. Cl. 707/100; 707/E17.044

(57) ABSTRACT

A computer-implemented method of building an integrated hierarchy from hierarchy components is disclosed. The method includes receiving a hierarchy structure having at a node element, extracting hierarchy attribute information associated with the node element, and building an integrated hierarchy based on the received hierarchy structure and the extracted hierarchy attribute information.

### TECHNICAL FIELD

The present disclosure is directed to the field of data representation and, more particularly, to a hierarchy creation and management tool.

### BACKGROUND

Various tools have been developed for representing information to be used by, and shared across, information systems, such as the Internet. Markup languages, such as Extensible Markup Language (XML), Hypertext Markup Language (HTML), and Standard Generalized Markup Language (SGML), utilize tags to annotate data and thereby define the structure of a document. To promote efficiency and ease of use, standards have been developed to ensure documents created using markup languages are uniform in structure. The World Wide Web Consortium (WWWC), for example, defines a “well formed” XML document as one which has, among other things, a hierarchical structure. Specifically, a “well formed” XML document must have one root, or parent, node element that includes all other node elements in the document.

As the complexity and content of these documents grow, the computing resources required to create, store, access, display, transfer, and/or otherwise manage these documents increases. Thus, there is a need to reduce or intelligently allocate the computing resources used in handling these documents. One tool developed for managing large XML documents is described in U.S. Pat. No. 7,210,097 issued to Clark et al. on Apr. 24, 2007 (“the '097 patent”). The tool of the '097 patent loads XML documents as they are needed. Specifically, a single XML document is broken up into one root, or parent, XML document and one or more child XML documents. Initially, only the parent XML document is loaded. The child XML documents are not loaded unless they are called upon.

While the tool of the '097 patent may help reduce computing resources required to manage a large XML document, it may still be inefficient. For example, the parent XML document may contain attributes and/or other items, apart from child elements, that are not needed during a given instance of using the XML document. Similarly, a child XML document may also contain items that are not used even if the child XML document is loaded. Nonetheless, these items may still be loaded, and computing resources may be wasted.

The present disclosure is directed to overcoming one or more of the problems set forth above.

### SUMMARY

One aspect of the disclosure is directed to a computer-readable medium having stored thereon computer-readable instructions which, when executed by a computer, cause the computer to perform a method of building an integrated hierarchy from hierarchy components. The method may include receiving a hierarchy structure having at a node element, extracting hierarchy attribute information associated with the node element, and building an integrated hierarchy based on the received hierarchy structure and the extracted hierarchy attribute information.

Another aspect of the disclosure is directed to a computer-implemented method of building an integrated hierarchy from hierarchy components. The method may include receiving a hierarchy structure having a node element, extracting hierarchy attribute information associated with the node element, and building an integrated hierarchy based on the received hierarchy structure and the extracted hierarchy attribute information.

Yet another aspect of the disclosure is directed to a computer system. The computer system may include a memory, an input device, and a processor in communication with the memory and the input device. The processor may be configured to receive a hierarchy structure having a node element, to extract hierarchy attribute information associated with the node element, and to build an integrated hierarchy based on the received hierarchy structure and the extracted hierarchy attribute information.

### BRIEF DESCRIPTION OF THE DRAWINGS

FIG. 1 shows a representation of an exemplary disclosed hierarchy management environment;

FIG. 2 shows a representation of exemplary disclosed hierarchy information that may be used by the hierarchy management environment of FIG. 1;

FIG. 3 shows a representation of an exemplary disclosed hierarchy structure file used by the hierarchy management environment of FIG. 1;

FIG. 4 shows a representation of an exemplary disclosed hierarchy attribute table used by the hierarchy management environment of FIG. 1;

FIG. 5 shows a representation of an exemplary disclosed integrated hierarchy table used by the hierarchy management environment of FIG. 1;

FIG. 6 shows a representation of an exemplary disclosed graphical user interface (GUI) executed by the hierarchy management environment of FIG. 1; and

FIG. 7 shows a flowchart depicting exemplary disclosed operation of the hierarchy management environment of FIG. 1.

### DETAILED DESCRIPTION

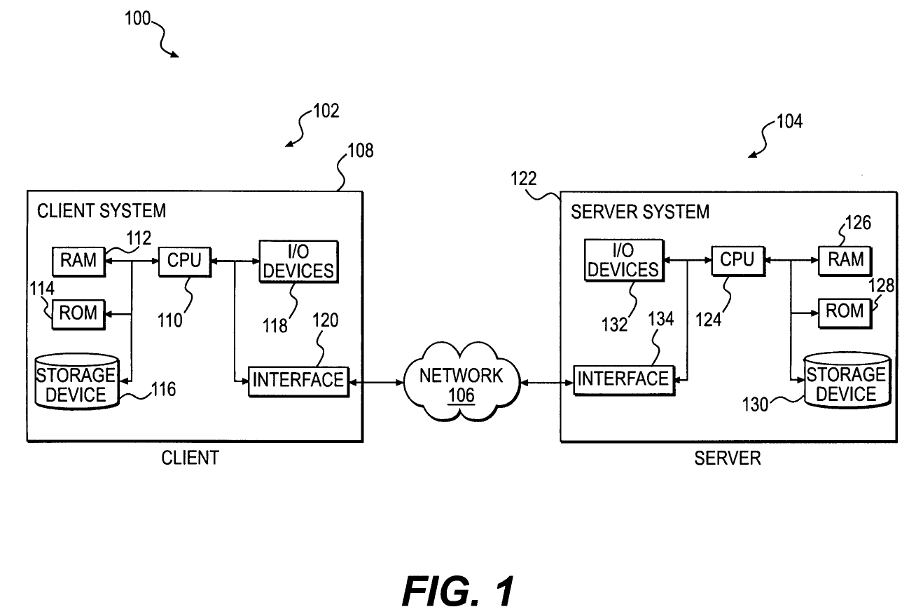

FIG. 1 shows a block diagram illustrating an exemplary disclosed hierarchy management environment 100 for implementing the present disclosure. Environment 100 may include any type of computing environment for, among other things, creating, storing, accessing, displaying, transferring, or otherwise managing hierarchical data. Environment 100 may include a client 102 in communication with a server 104 via a network 106 (e.g., the Internet, a dedicated intranet, or another packet-switched network).

Client 102 may include one or more client systems 108 that receive input from, and provide output to, a user in connection with creating, storing, accessing, displaying, transferring, or otherwise managing hierarchical data. Client 102 may represent, for example, a personal- or employee-user of client system 108 in a home or office.

Client system 108 may be a platform including any type of processor-based system on which processes and methods consistent with the disclosed embodiments may be implemented. Client system 108 may include, for example, a desktop computer, a laptop computer, a personal digital assistant (PDA), a hand-held computer (e.g., a Pocket PC, a blackberry®), a cellular telephone, or any other computing system known in the art.

As illustrated in FIG. 1, client system 108 may include one or more hardware and/or software components configured to execute software programs. For example, client system 108 may include one or more hardware components, such as a central processing unit (CPU) 110 in communication with random access memory (RAM) 112, a read-only memory (ROM) 114, a storage device 116, one or more input/output (I/O) devices 118, and an interface 120. Client system 108 may include one or more software components, such as a computer-readable medium including computer-executable instructions for performing methods consistent with disclosed embodiments. One or more of the hardware components listed above may be implemented using software. For example, storage device 116 may include a software partition associated with one or more other hardware components of client system 108. Client system 108 may include additional, fewer, and/or different components than those listed above, as the components listed above are exemplary only and not intended to be limiting.

CPU 110 may include one or more processors configured to execute instructions and to process data to perform one or more functions associated with client system 108. As illustrated in FIG. 1, CPU 110 may be communicatively coupled to RAM 112, ROM 114, storage device 116, I/O devices 118, and interface 120. CPU 110 may be configured to execute sequences of computer program instructions to perform various processes, which will be described in detail below. The computer program instructions may be loaded into RAM 112 for execution by CPU 110.

RAM 112 and ROM 114 may each include one or more devices for storing information associated with operations of client system 108. RAM 112 may include a memory device for storing data associated with one or more operations of CPU 110. For example, RAM 112 may include static RAM (SRAM) and/or dynamic RAM (DRAM). ROM 114 may include erasable programmable read-only memory (EPROM), electrically erasable programmable read-only memory (EEPROM), or any other suitable ROM device. Instructions from ROM 114 may loaded into RAM 112 for execution by CPU 110. ROM 114 may be configured to access and to store information for identifying, initializing, and monitoring the operation of one or more components and subsystems of client system 108.

Storage device 116 may include any type of mass storage device configured to store information that CPU 110 may need to perform processes consistent with the disclosed embodiments. For example, storage device 116 may include one or more magnetic and/or optical disk devices, such as a hard drive, CD-ROM, DVD-ROM, a Flash drive, and/or any other type of mass media storage device.

I/O devices 118 may include one or more components configured to communicate information to/from a user of client system 108. For example, I/O devices 118 may include a console with an integrated keyboard and mouse to allow a user to input parameters associated with client system 108. I/O devices 118 may also include a display (e.g., an LCD, a CRT display, or a plasma display) including a graphical user interface (GUI) executed by client system 108 for inputting/outputting information. I/O devices 118 may also include peripheral devices such as, for example, a printer for printing information associated with client system 108; a user-accessible disk drive (e.g., a USB port, a floppy, CD-ROM, or DVD-ROM drive, etc.) to allow a user to input data stored on a portable media device; a microphone; a speaker; and/or any other suitable type of interface device for inputting and/or outputting information to and/or from a computing system. The results of received data may be provided as output from client system 108 via I/O devices 118 for printed display, viewing, and/or further communication to other system devices.

Interface 120 may include one or more components configured to transmit and to receive data through network 106. Interface 120 may include and/or otherwise be associated with appropriate network architecture (not shown) to facilitate such communication. The network architecture may include, alone or in any suitable combination, one or more modulators, demodulators, multiplexers, demultiplexers, antennas, modems, gateways, routers, and/or any other devices configured to enable data communication via network 106, e.g., a telephone-based network (such as PBX or POTS), a local area network (LAN), a wide area network (WAN), a dedicated intranet, a workstation peer-to-peer network, a direct link network, a wireless network, etc.

Server 104 may represent a computing system of any entity that transmits, receives, and/or stores information for client 102 in connection with creating, storing, accessing, displaying, transferring, or otherwise managing hierarchical data. For example, server 104 may represent the computing system of a corporate office, a home office, a data service provider, a website, or any other entity that may use or manage hierarchical data. Although illustrated as a single client 102 and a single server 104, a plurality of clients 102 may be connected to either a single, centralized server 104 or a plurality of distributed servers 104 connected via a local network (not shown).

Server 104 may include a server system 122 configured provide information to, receive information from, and/or perform other operations related to the management of hierarchical data for client 102. Server system 122 may include any type of processor-based system on which processes and methods consistent with the disclosed embodiments may be implemented. For example, server system 122 may be desktop or laptop computer, one or more designated server computers connected via a network, or any other suitable server computing system owned or otherwise controlled by the entity of server 104.

As shown in FIG. 1, server system 122 may include components similar to those discussed above in connection with client system 108. Namely, server system 122 may include a CPU 124, RAM 126, ROM 128, a storage device 130, I/O devices 132, and/or an interface 134. These components may have structure and/or functionality similar to their counterparts discussed above in connection with client system 108.

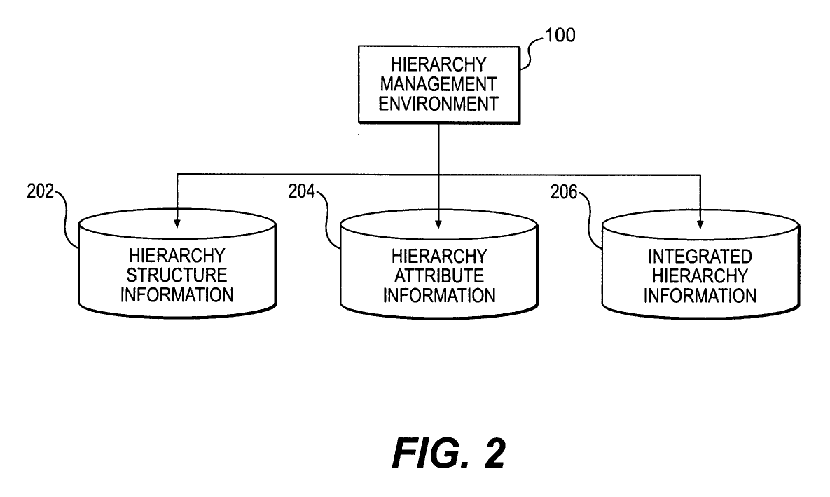

FIG. 2 shows an exemplary representation of hierarchy information 200 that may be used by environment 100. Hierarchy information may include hierarchy structure information 202, hierarchy attribute information 204, and integrated hierarchy information 206. Environment 100 may leverage hierarchy structure information 202 and hierarchy attribute information 204 to create integrated hierarchy information 206. That is, hierarchy structure information 202 may be applied to hierarchy attribute information 204 to build integrated hierarchy information 206.

Hierarchy structure information 202 may be stored on, for example, storage device 116, storage device 130, or in associated memory. Hierarchy structure information 202 may include information describing the structure of one or more documents used by environment 100. For example, hierarchy structure information 202 may describe a folder structure (e.g., folders and sub-folders), a website structure (e.g., the layout of a website), a structure of operational data gathered for analysis (e.g., operational data gathered from a fleet of machines or products), a structure of an executable application (e.g., an electronic bill payment application), and/or any other structured data.

Hierarchy structure information 202 may include an Extensible Markup Language (XML) document, Hypertext Markup Language (HTML) document, a standard Generalized Markup Language (SGML) document, or any other markup language document in which tags and/or syntax are used to annotate data for structural representation by a computer system, for sharing across information systems (e.g., the Internet), and/or for other applications. Hierarchy structure information 202 may allow for the definition of elements having attributes and links. In one embodiment, hierarchy structure information 202 may conform to a document-type definition (DTD), a schema (e.g., an XML Schema), style sheet (e.g., an HTML style sheet), or another standard defining a format to which information in an electronic document may adhere (e.g., WWWC standards).

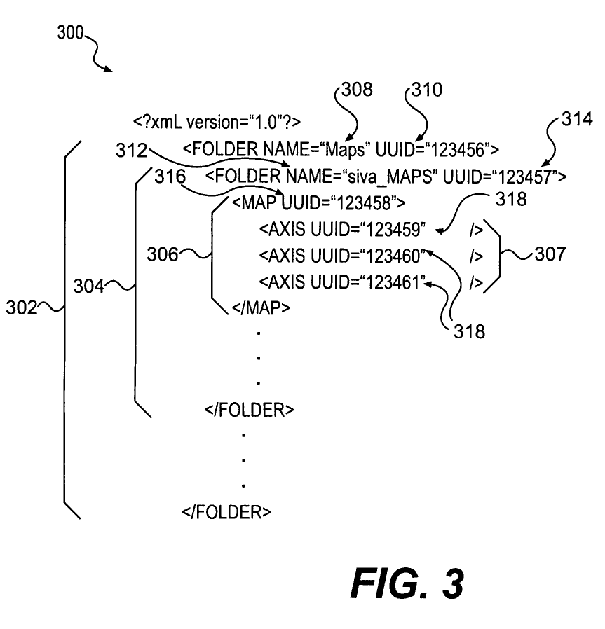

As shown in FIG. 3, hierarchy structure information 202 may include one or more hierarchy structure files 300 (e.g., an XML file, an HTML file, or an SGML file) for defining the structure or the manner in which hierarchy attribute information 204 is conveyed or represented. That is, hierarchy structure information 202 may include the framework, or “skeleton,” defining the structure of hierarchy attribute information 204.

Hierarchy structure information 202 may be hierarchical in nature. For instance, hierarchy structure file 300 may include one or more first tier node elements 302 (e.g., a “parent” or “root” node element), one or more second tier node elements 304 (e.g., “child” node elements) nested within first tier node element 302, one or more third tier node elements 306 (e.g., “grandchild” node elements) nested within second tier node elements 304, one or more fourth tier node elements 307 (e.g., great grandchild node elements) nested within third tier node elements 306. Node elements 302-307 may tag, annotate, map to, otherwise describe associated information in hierarchy attribute information 204.

First tier node element 302 may reference or describe a generic category of information contained in hierarchy attribute information 204. Continuing with the example above in which hierarchy structure information 202 includes information describing the structure of operational data gathered from a fleet of machines or products for analysis, first tier node element 302 may correspond to a particular type of machine or product in the fleet for which operational data has been gathered (e.g., a 2008 Model 966E wheel loader). In other examples, first tier node element 302 may correspond to a file directory (e.g., C:), a website home page, a table of contents of a document, and/or other generic, high-tier categories subsuming other information within a document.

First tier node element 302 may include and/or otherwise be associated with items such as a name 308 and a reference ID 310 (e.g., a universally unique identifier, or “UUID”), among other things, for referencing or describing attributes of first tier node element 302. Name 308 may include a name of first tier node element 302. Continuing with the example above, name 308 may include the name of the machine or product for which operational data has been gathered (e.g., “2008 Model 966E wheel loader”). In other examples, name 308 may include the name of the directory (e.g., “C:”), the name of a website home page (e.g., “XYZ Bank”), the name of the table of contents of a book (e.g., “table of contents”), etc. Reference ID 310 may include strings of characters or the like referencing, or pointing to, a corresponding record in hierarchy attribute information 204 containing information associated with first tier node element 302, which will be discussed in further detail below.

Second tier node elements 304 may reference or describe a specific category of information within first tier node element 302. Continuing with the example above in which hierarchy structure information 202 includes information describing operational data gathered from a fleet of machines or products for analysis, second tier node elements 304 may correspond to particular systems for which operational data has been gathered for the particular machine type (i.e., first tier node element 302), such as, for example, the brake system, the fuel system, the hydraulic system, the engine system, and/or other systems. In other examples, second tier node elements 304 may correspond to subfolders or subdirectories within the directory associated with first tier node element 302 (e.g., “My Documents, “Programs,” or another folder), hypertext links on the homepage associated with first tier node element 302, chapters within the table of contents associated with first tier node element 302, and/or other specific categories of information within first tier node element 302.

Second tier node elements 304, like first tier node element 302, may include and/or otherwise be associated with a name 312 and a reference ID 314 (e.g., a UUID), among other things, for referencing or describing attributes of second tier node elements 304. Name 312 may include the names of second tier node elements 304. Continuing with the example above, name 312 may include the names of systems of the particular machine or product (i.e., first tier node element 302) for which operational data has been gathered (e.g., “brake system,” “fuel system,” “hydraulic system,” “engine system,” etc.). In other examples, name 312 may include the names of subfolders or subdirectories within the directory associated with first tier node element 302 (e.g., “My Documents,” “Programs,” etc.), the names the hypertext links on the homepage associated with first tier node element 302 (e.g., “Contact Us,” “Store Locator,” etc.), the names of the chapters in the table of contents associated with first tier node element 302 (e.g., “Chapter 1,” “Chapter 2,” etc.), and/or the names of other categories of information subsumed by first tier node element 302. Reference ID 314 may include strings of characters or the like referencing, or pointing to, a corresponding record in hierarchy attribute information 204 containing information associated with second tier node elements 304, which will be discussed in further detail below.

Similarly, third tier node elements 306 and fourth tier node elements 307, like first tier node element 302 and second tier node elements 304, may include information such as a names (not shown ) and reference IDs 316 and 318 (e.g., a “UUID”), respectively. Continuing with the example above, third tier node elements 306 may correspond to maps, graphs, or plots of the operational data gathered for the systems associated with second tier node elements 304 (e.g., a fuel efficiency graph, an engine torque output graph, a hydraulic pressure graph, etc.).

Fourth tier node elements 307 may correspond to the actual operational parameters monitored for each map, graph, or plot associated with third tier node elements 306 (e.g., time, engine speed, torque output, amount of fuel consumed, oil pressure, hydraulic pressure, etc.). In this manner, reference IDs 316 and 318 may reference, or point to, corresponding records in hierarchy attribute information 204 containing information associated with third tier node elements 306 and fourth tier node elements 307, respectively.

The foregoing description of hierarchy structure file 300 it not intended to be limiting. Hierarchy structure file 300 may contain any information suitable for hierarchically annotating, tagging, mapping, or otherwise describing the manner in which information in hierarchy attribute information 204 is to be arranged, conveyed, and/or otherwise structured.

Hierarchy attribute information 204 may include information to be structured by environment 100 using hierarchy structure information 202. That is, hierarchy attribute information 204 may contain hierarchically unstructured information (i.e., “raw” or “flat” data) to which hierarchy structure information 202 may be applied to generate integrated hierarchy information 206 (i.e., an intergrated hierarchy including both structure and associated content and/or attributes). Hierarchy attribute information 204 be stored on, for example, storage device 116, storage device 130, or in associated memory.

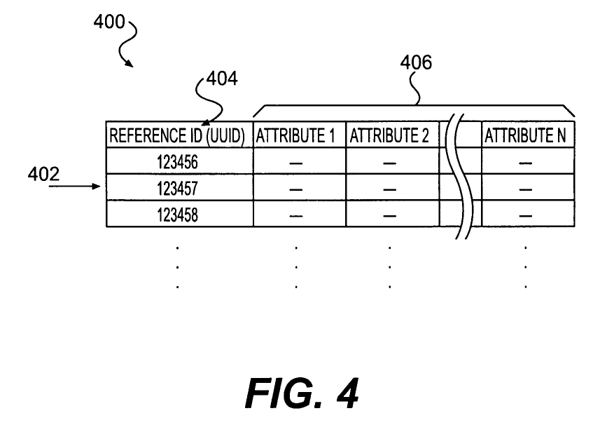

Referring to FIG. 4, hierarchy attribute information 204 may include a database that conforms to a relational model (e.g., a relational database) or another type of database. Hierarchy attribute information 204 may include a collection of relations or tables that annotate, tag, or label data stored therein. While hierarchy attribute information 204 may be structured in this sense, hierarchy attribute information 204 may be hierarchically unstructured. In one embodiment, hierarchy attribute information 204 may contain any data, information, attributes, and/or content not included in hierarchy structure information 202 that may be required to form an integrated hierarchy. In other words, while hierarchy structure information 202 may contain the structure of the hierarchy, hierarchy attribute information 204 may contain attributes of, and/or content associated with, the hierarchy structure.

For example, hierarchy attribute information 204 may include one or more hierarchy attribute tables 400 of tagged records 402. Each record 402 may include a reference ID field 404 and one or more attribute fields 406. Reference ID field 404 may correspond to reference IDs 310, 314, 316, and 318 indicated by node elements 302-307, etc., respectively. Attribute fields 406 may contain attribute data or content for each record 402 (indicated by the respective reference IDs).

For instance, continuing with the example above (gathering operational data from a fleet of machines or products), attribute fields 406 corresponding to first tier node elements 302 may indicate attributes of the machines or products. For example, attribute fields 406 may indicate serial numbers, model numbers, model names, configurations, operator identities, owner identities, manufacturing dates, and/or other attributes or identifying information

Likewise, attribute fields 406 corresponding to second tier node elements 304 may indicate attributes of the systems (e.g., the fuel system, the hydraulics system, the engine system, etc.) of the machines for which operational data has been gathered. For example, attribute fields 406 may indicate system names, configurations, software versions, model numbers, maintenance history, and/or other attributes, characteristics, or information about the systems of the machines or products.

Similarly, attribute fields 406 corresponding to third tier node elements 306 may indicate attributes of the particular plots, graphs, or charts of operational data gathered for the systems. For example, attribute fields 406 may indicate a type of the plot (e.g., Cartesian, bar graph, pie chart, etc.), a name of the plot (e.g., “Fuel Efficiency”), a name of the plot (e.g., “engine torque map”), a shading style of the plot (e.g., hatched, gray scale, color, etc.), a resolution of the plot, a trace mode of the plot (e.g., solid line, dotted line, hatched line, etc.), an offset of the plot, and/or other attributes, characteristics, or information about of a plot.

Further, attribute fields 406 corresponding to fourth tier node elements 307 may indicate attributes of axes associated with the graphs or plots. For example, attribute fields 406 may specify the axes (e.g., X, Y, or Z axis), labels or names for the axes (e.g., time, engine speed, fuel consumed, pressure), numerical values for data points on the axes, units of the data points (e.g., seconds, liters, psi, degrees Kelvin, etc.), a tolerance of the data point values, dates and/or times during which the data points were measured or gathered, and/or other attributes, characteristics, or information about the axes.

While hierarchy attribute information 204 has been discussed above as primarily including information and/or attributes relating to operational data gathered for a fleet of machines or products, it is to be appreciated that hierarchy attribute information 204 may include any data associated with hierarchy structure information 202. That is, hierarchy attribute information 204 may include any data or content that is hierarchically unstructured and to which hierarchy structure information 202 may be applied to create an integrated hierarchy, which will be further discussed below. For example, in the case where hierarchy structure information 202 relates to the layout of a website, hierarchy attribute information 204 may contain the actual content of the website (e.g., text, images, executable routines, etc.). Thus, applying hierarchy structure information 202 to hierarchy attribute information 204 may result in a complete website. Similarly, where hierarchy structure information 202 relates to the layout of a document, such as a book (e.g., a table of contents), hierarchy attribute information 204 may contain the actual content of the document (e.g., the text of the book). Thus, applying hierarchy structure information 202 to hierarchy flat data 202 may result in a structured document (e.g., a book).

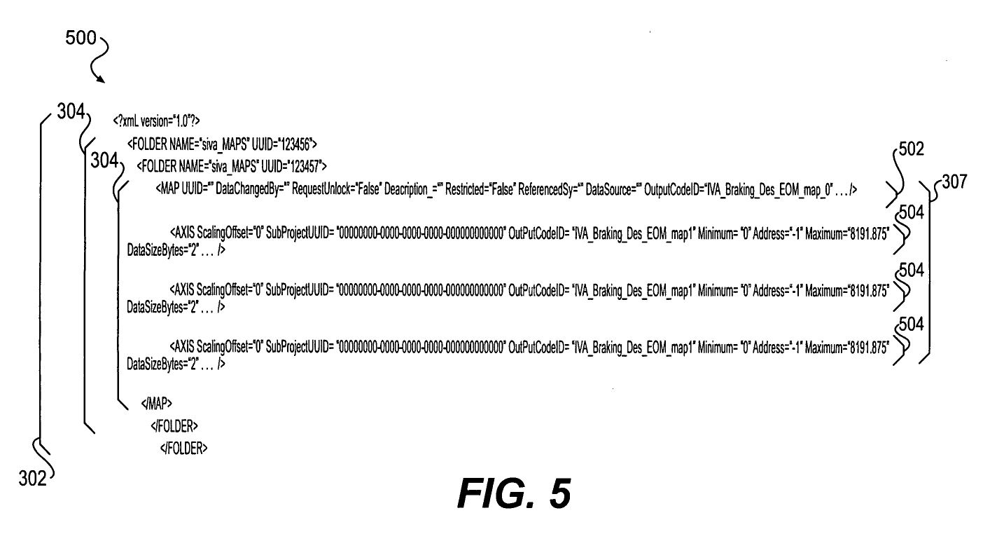

Integrated hierarchy information 206 may include the structured hierarchy created by the application of hierarchy structure data 202 to hierarchy attribute information 204. In particular, environment 100 may access a hierarchy structure file 300 contained in hierarchy structure information 202 and identify and read reference IDs 310, 314, 316, and 318 associated with node elements 302-307. Environment 100 may then query or otherwise search hierarchy attribute tables 400 contained in hierarchy attribute information 204 for the identified reference IDs 310, 314, 316, and 318, and extract attribute information from the associated records 402. Environment 100 may then use this information, in conjunction with hierarchy structure file 300, to create an integrated hierarchy file 500 (e.g., an XML file, an HTML file, a SGML file, etc.) (FIG. 5).

As shown in FIG. 5, like hierarchy structure file 300, an integrated hierarchy file 500 may include first through fourth tier node elements 302-307. In addition, however, integrated hierarchy file 500 may include node attribute information 502-504 inserted into respective node elements 302-305. For example, integrated hierarchy file 500 may include third tier additional node attribute information 502 inserted into third tier node elements 306, and fourth tier additional node information 504 inserted into fourth tier hierarchy node elements 307. This may be accomplished by extracting from hierarchy attribute information 204 (i.e., from hierarchy attribute table 400) attribute information included in records 402 corresponding to reference IDs 310, 314, 316, and 318 (i.e., attributes contained in attribute fields 406) and creating integrated hierarchy file 500 using hierarchy structure file 300 and the extracted attribute information. In this manner, an integrated, structured hierarchy (e.g., an XML or HTML file) may be built from hierarchy structure information 202 and hierarchy attribute information 204.

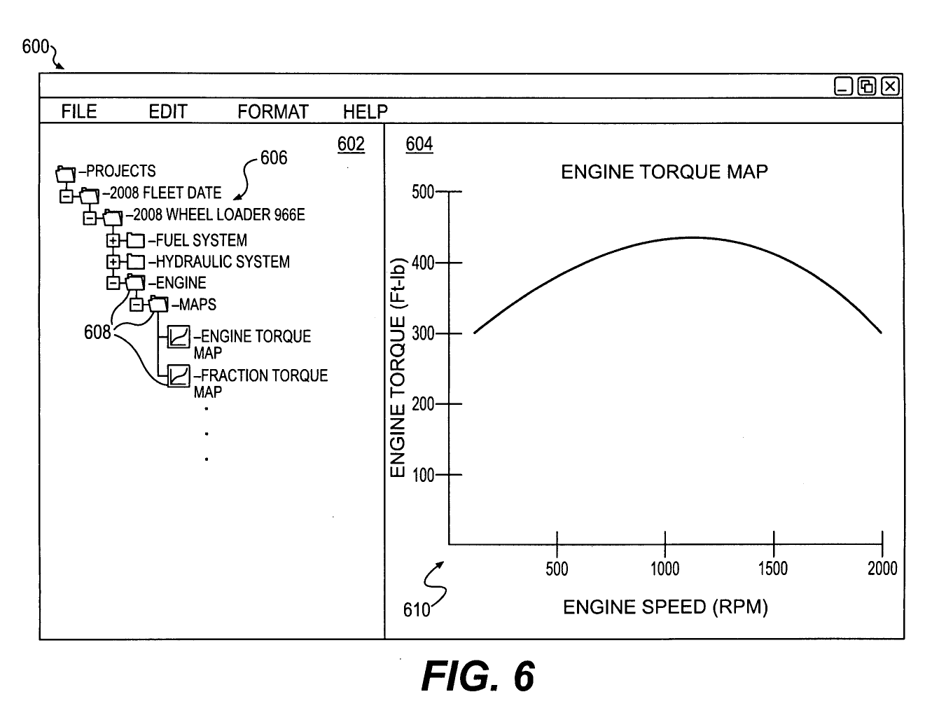

FIG. 6 shows an exemplary graphical user interface application (GUI) 600 that may be implemented by environment 100. GUI 600 may provide for creating, storing, accessing, displaying, transferring, or otherwise managing hierarchical data. GUI 600 may be a software tool run by client system 108 and provided to a user of client system 108, a software tool run by server system 122 and provided to a user of client system 108, a webpage application maintained by server system 122 and provided to a user of client system 108 via network 106; and/or any other application.

Referring to FIG. 6, GUI 600 may include a hierarchy structure display window 602 and a hierarchy attribute display window 604. Hierarchy structure display window 602 may include an expanding/collapsing hierarchy structure 606 defined by hierarchy structure information 202. For example, a user of GUI 600 may select a desired project (e.g., a project file) stored by environment 100 (e.g., 2008 Fleet Data). GUI 600 may then access a respective hierarchy structure file 300 from hierarchy structure information 202 (e.g., stored on storage device 116). GUI 600 may then read the hierarchy structure file 300 and display hierarchy structure 606 in window 602. Hierarchy structure 606 may include one or more nodes 608 corresponding to node elements 302-307 contained in hierarchy structure file 300.

Hierarchy structure 606 may be selectable by the GUI user. For example, the user may select with the mouse desired nodes 608. Selection of the “2008 Wheel Loader 966E” node 608, for example, may cause GUI 600 to retrieve a respective reference ID 310 from first tier node element 302 in hierarchy structure file 300. GUI 600 may then query or search hierarchy attribute table 400 for a record 402 corresponding to the reference ID 310 (i.e., reference ID field 404), and extract from hierarchy attribute table 400 the attributes associated with the reference ID 310 (i.e., in attribute fields 406). This information may be stored in memory for future reference.

The user may then select, for example, a node 608 in hierarchy structure 606 corresponding to “Engine.” In response, GUI 600 may retrieve a respective reference ID 314 from a corresponding second tier node element 304 in hierarchy structure file 300. GUI 600 may then query or search hierarchy attribute table 400 for a record 402 corresponding to the reference ID 314 (i.e., contained in reference ID field 404), and extract from hierarchy attribute table 400 the attributes associated with the reference ID 314 (i.e., contained in attribute fields 406). This information may be stored in memory for future reference.

Likewise, the user may then select, for example, a node 608 in hierarchy structure 606 corresponding to “Maps” (i.e., maps associated with the “Engine” system). In response, GUI 600 may retrieve a respective reference ID 316 from an appropriate third tier node element 306 in hierarchy structure file 300. GUI 600 may then query or search hierarchy attribute table 400 for a record 402 corresponding to reference ID 316 (i.e., contained in reference ID field 404), and extract from hierarchy attribute table 400 the attributes associated with the reference ID 316 (i.e., contained in attribute fields 406). This information may be stored in memory for future reference.

Further, the user may then select, for example, a node 608 in hierarchy structure 606 corresponding to “Engine Torque Map.” In response, GUI 600 may retrieve respective reference IDs 318 from appropriate fourth tier node elements 307 in hierarchy structure file 300. GUI 600 may then query or search hierarchy attribute table 400 for a record 402 corresponding to the references ID 318 (i.e., contained in reference ID field 404), and extract from hierarchy attribute table 400 the attributes associated with the reference IDs 318 (i.e., contained in attribute fields 406). This information may be stored in memory for future reference.

GUI 600 may then build an integrated hierarchy file 500 (e.g., an XML file, HTML file, or SGML file) based on hierarchy structure file 300 and the extracted attribute information corresponding to the selected nodes 608. Namely, GUI 600 may insert the extracted attribute information 502-504 into appropriate node elements 302-307 as discussed above (see FIG. 5). In this manner, GUI 600 may build an integrated hierarchy file 500 based on, and commensurate with, the user's selection. Specifically, integrated hierarchy file 500 may contain only the attribute information required by the user's selection, rather than all of the attribute information associated with the hierarchy structure. Thus, computing resources may be conserved in connection with environment's 100 handling and processing of integrated hierarchy file 500.

Upon completion of the user's selection of nodes 608, GUI 600 may perform any additional required processing. For example, GUI 600 may display in hierarchy attribute display window 604 a chart 610 based on integrated hierarchy file 500 (e.g., an engine torque map). It is to be appreciated however, that such additional processing may depend on the nature of the nature of the information contained in hierarchy structure file 300 and hierarchy attribute table 400. In other examples, the additional processing could include displaying the contents of a book or another document, playing an audio or video clip, executing a portion of a program or application, and/or any other processing that may be achieved by applying hierarchy structure information 202 to hierarchy attribute information 204 to create an integrated, structured document.

In addition, the use may use GUI 600 to edit or modify the hierarchy. For example, the user may use hierarchy structure display window 602 or hierarchy attribute display window 604 to add or remove node elements 608 from hierarchy structure 606 and/or to modify attributes of the hierarchy. GUI 600 may modify integrated hierarchy file 500 in response. When the user saves these changes, GUI 600 may extract from integrated hierarchy file 500 the hierarchy structure information (e.g., node elements 302-307), and update hierarchy structure file 300 accordingly. Similarly, GUI 600 may extract from integrated hierarchy file 500 hierarchy attribute information (e.g., node attribute information 502-504), and update hierarchy attribute table 400 accordingly. In this manner, hierarchy structure information 202 and hierarchy attribute information 204 may be independent from one another. That is, one may be modified without modifying the other.

### INDUSTRIAL APPLICABILITY

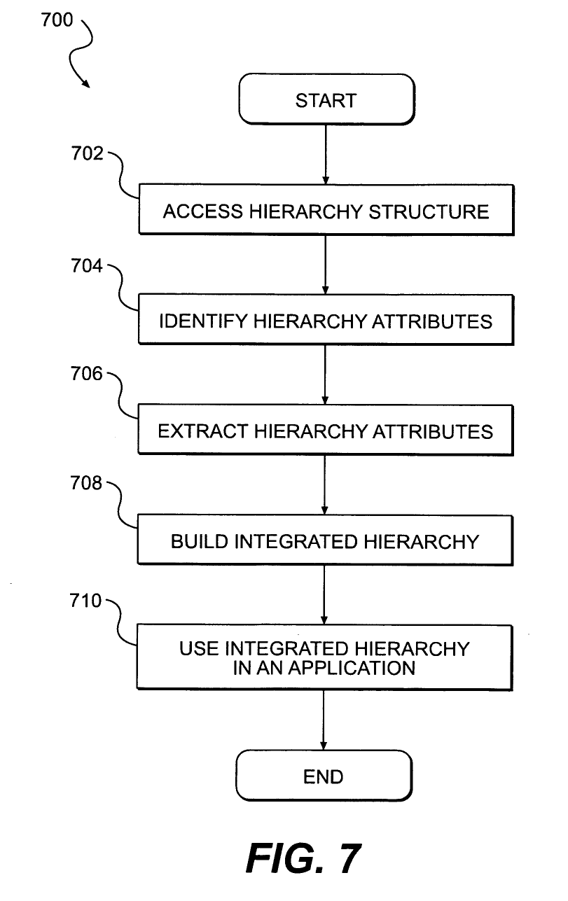

The disclosed methods and systems may provide a hierarchy creation and management tool. In particular, the disclosed methods and systems may be used create an integrated hierarchy from hierarchy components; specifically, from hierarchy structure information and hierarchy attribute information. In this manner, an integrated hierarchy containing only attributes required by the particular application may be built, rather than all of the attributes associated with the hierarchy structure. Operation 700 of environment 100 will now be discussed in connection with FIG. 7.

First, a user of GUI 600 may access hierarchy structure information 202 (step 702). For example, the user may select and load a project (e.g., a project file) stored by environment 100 (e.g., “2008 Fleet Data”), as discussed above. GUI 600 may then access an associated hierarchy structure file 300 from hierarchy structure information 202 (e.g., stored on storage device 116). GUI 600 may then read hierarchy structure file 300 and display hierarchy structure 606 in window 602.

Next, hierarchy attributes may be identified (step 704). For example, the user may select desired nodes 608 in hierarchy structure 606 displayed in window 602, as discussed above. GUI 600 may retrieve respective reference IDs 310, 314, 316, and 318 from node elements 302-307 in hierarchy structure file 300 corresponding to the user's selection.

GUI 600 may then extract hierarchy attribute information associated with the hierarchy (step 706). Specifically, GUI 600 may load a corresponding hierarchy attribute file and query or search hierarchy attribute table 400 for records 402 corresponding to the reference IDs 310, 314, 316, and 318 retrieved in step 704 (i.e., contained in reference ID field 404). GUI 600 may then extract from hierarchy attribute table 400 the attributes associated with the reference IDs 310, 314, 316, and 318 retrieved in step 704 (i.e., contained in attribute fields 406). This information may be stored in memory for future reference.

GUI 600 may then build an integrated hierarchy file 500 (e.g., an XML, HTML, or SGML file) based on hierarchy structure file 300 and the attribute information extracted in step 706 (step 708). In particular, GUI 600 may insert the extracted attribute information 502-504 into appropriate node elements 302-307, as discussed above (see FIG. 5). Once built, integrated hierarchy file 500 may be used in an application (step 710). For example, GUI 600 may use integrated hierarchy file 500 to display a chart 610 or in another application.

By employing the disclosed hierarchy creation and management tool, computing resources may be conserved. Specifically, because the hierarchy structure is separate from the hierarchy attributes, it is not required that a complete hierarchy (i.e., the entire hierarchy) be built each time the hierarchy structure is accessed. For example, only the hierarchy structure may be loaded, viewed, edited, transmitted (e.g., emailed) by the user. In addition, building an integrated hierarchy containing only those attributes required for the application (e.g., in response to a user's selection), rather than every attribute associated with the hierarchy structure, the computing demands associated with managing the hierarchy may be reduced.

Further, multiple hierarchy structures may be applied to the same hierarchy attributes (i.e., hierarchy content) to produce different hierarchies. In other words, the same hierarchy attributes may be organized, presented, or otherwise conveyed in different ways, by the application of different hierarchy structures to the same hierarchy attributes. In this manner, different versions of the same hierarchy may be created without generating complete hierarchies for each different version (i.e., entire hierarchies, including all hierarchy structure information and all associated hierarchy attributes). Instead, only different hierarchy structures may be required; the same hierarchy attribute information may be used with each hierarchy structure. This may advantageously reduce the computing resources required to accommodate multiple different hierarchies that organize, present, or otherwise convey the same hierarchy attributes in different ways.

Those skilled in the art will appreciate that all or part of systems and methods consistent with the present disclosure may be stored on or read from other computer-readable media. Environment 100 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) 114 and/or 128 or random-access memory (RAM) 112 and/or 126. Such computer-readable media may be embodied by one or more components of parts-ordering environment 100, such as storage device 116 and/or 130, CPU 110 and/or 124, or combinations of these and other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The described implementation may include a particular network configuration but embodiments of the present disclosure may be implemented in a variety of data communication network environments using software, hardware, or a combination of hardware and software to provide the processing functions.

It will be apparent to those skilled in the art that various modifications and variations can be made to the disclosed hierarchy creation and management tool. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium having stored thereon computer-readable instructions which, when executed by a computer, cause the computer to perform a method of building an integrated hierarchy from hierarchy components, the method comprising:
receiving a hierarchy structure having a node element;
extracting hierarchy attribute information associated with the node element; and
building an integrated hierarchy based on the received hierarchy structure and the extracted hierarchy attribute information.

2. The computer-readable medium of claim 1, wherein:
the hierarchy structure includes a reference identifier associated with the node element, and
the hierarchy attribute information is extracted based on the reference identifier.

3. The computer-readable medium of claim 1, wherein building an integrated hierarchy includes inserting into the hierarchy structure the extracted hierarchy attribute information.

4. The computer-readable medium of claim 1, wherein:
the hierarchy structure is received from a first source, and
the hierarchy attribute information is extracted from a second source.

5. The computer-readable medium of claim 4, wherein:
the first source and the integrated hierarchy include separate markup language documents, and
the second source includes a relational database.

6. The computer-readable medium of claim 5, wherein the markup language includes one of Extensible Markup Language (XML), Standard Generalized Markup Language (SGML), and Hypertext Markup Language (HTML).

7. The computer-readable medium of claim 1, the method further including:
displaying the hierarchy structure; and
receiving a selection of the node element,
wherein the extraction of the hierarchy attribute information and the building of the integrated hierarchy are responsive to the selection.

8. A computer-implemented method of building an integrated hierarchy from hierarchy components, comprising:
receiving a hierarchy structure having a node element;
extracting hierarchy attribute information associated with the node element; and
building an integrated hierarchy based on the received hierarchy structure and the extracted hierarchy attribute information.

9. The method of claim 8, wherein:
the hierarchy structure includes a reference identifier associated with the node element, and
the hierarchy attribute information is extracted based on the reference identifier.

10. The method of claim 8, wherein building an integrated hierarchy includes inserting into the hierarchy structure the extracted hierarchy attribute information.

11. The method of claim 8, wherein:
the hierarchy structure is received from a first source, and
the hierarchy attribute information is extracted from a second source.

12. The method of claim 11, wherein:
first source and the integrated hierarchy include separate markup language documents, and
the second source includes a relational database.

13. The method of claim 8, further including:
displaying the hierarchy structure; and
receiving a selection of the node element,
wherein the extraction of the hierarchy attribute information and the building of the integrated hierarchy are responsive to the selection.

14. A computer system, comprising:
a memory;
an input device; and
a processor in communication with the memory and the input device, the processor being configured to:
receive a hierarchy structure having a node element;
extract hierarchy attribute information associated with the node element; and
build an integrated hierarchy based on the received hierarchy structure and the extracted hierarchy attribute information.

15. The computer system of claim 14, wherein:
the hierarchy structure includes a reference identifier associated with the node element, and
the hierarchy attribute information is extracted based on the reference identifier.

16. The computer system of claim 14, wherein building an integrated hierarchy includes inserting into the hierarchy structure the extracted hierarchy attribute information.

17. The computer system of claim 14, wherein:
the hierarchy structure is received from a first source, and
the hierarchy attribute information is extracted from a second source.

18. The computer system of claim 17, wherein:
first source and the integrated hierarchy include separate markup language documents, and
the second source includes a relational database.

19. The computer system of claim 18, wherein the markup language includes one of Extensible Markup Language (XML), Standard Generalized Markup Language (SGML), and Hypertext Markup Language (HTML).

20. The computer system of claim 14, the processor being further configured to:
display the hierarchy structure; and
receive, via the input device, a selection of the node element,
wherein the extraction of the hierarchy attribute information and the building of the integrated hierarchy are responsive to the selection.
